(19) United States
(12) Patent Application Publication
(10) Pub. No.: US 2010/0065343 A1
(43) Pub. Date: Mar. 18, 2010

(54) Fingertip Touch Pen

(76) Inventor: Chien-Liang Liu, Kaohsiung City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/212,705

(22) Filed: Sep. 18, 2008

(51) Int. Cl. G06F 3/033

(52) U.S. Cl. 178/19.01

(57) ABSTRACT

A fingertip touch pen includes a body having an annular clamping portion mounted around a finger of a user. The clamping portion includes a first side and a second side spaced from the first side along a longitudinal axis of the clamping portion. The body further includes an abutting portion formed on the clamping portion and protruding beyond the first side of the clamping portion. The abutting portion extends toward the longitudinal axis. The abutting portion is interconnected to the clamping portion at a portion that extends away from the second side of the clamping portion. The abutting portion is abutted against by a fingertip of the user. A touch member is coupled to an outer periphery of the clamping portion. The touch member includes a touch portion on an end thereof. The fingertip touch pen is securely positioned on the finger of the user, providing convenience of use.

### BACKGROUND OF THE INVENTION

1. Field of the Invention

The present invention relates to a touch pen and, more particularly, to a fingertip touch pen that can be mounted to a finger of a user.

2. Description of the Related Art

A typical conventional ring type touch pen includes an annular body and a pen having an end fixed to an outer periphery of the annular body. The annular body is mounted around a finger of a user. The user can touch a touch panel of an electronic device with the other end of the pen to operate the electronic device. However, the annular body can only be mounted around a finger of a certain size, leading to limitation of use. Specifically, mounting the touch pen around a finger having a size larger than the annular body is impossible. On the other hand, the annular body is liable to slide if it is mounted on a thin finger.

To solve the problems of the above ring type touch pen, the annular body is modified to be substantially C-shaped to allow passage of fingers of differing sizes. However, the C-shaped body is liable to slide when the pen comes in contact with an object, such that the user has to frequently adjust the position of the C-shaped body.

Thus, a need exists for a touch pen that can be securely mounted around fingers of differing sizes for various users.

### SUMMARY OF THE INVENTION

The primary objective of the present invention is to provide a fingertip touch pen that can be securely mounted on a finger of a user.

A fingertip touch pen according to the preferred teachings of the present invention includes a body and a touch member. The body includes an annular clamping portion adapted to be mounted around a finger of a user at a portion adjacent to a fingertip of the finger. The clamping portion includes a first side and a second side spaced from the first side along a longitudinal axis of the clamping portion. The body further includes an abutting portion formed on the clamping portion and protruding beyond the first side of the clamping portion. The abutting portion extends toward the longitudinal axis. The abutting portion is interconnected to the clamping portion at a portion that extends away from the second side of the clamping portion. The abutting portion is adapted to be abutted against by the fingertip of the user. The touch member is coupled to an outer periphery of the clamping portion. The touch member includes a touch portion on an end thereof. By such an arrangement, the body can be mounted around fingers of differing sizes and movement of the body relative to the finger is avoided by the abutting portion, such that the fingertip touch pen is securely positioned on the finger of the user, providing convenience of use.

In a most preferred form, the clamping portion is substantially C-shaped and includes two ends having a gap therebetween. The ends are adapted for clamping the finger of the user. The abutting portion is arcuate and has a distal end not connected to the clamping portion. The distal end of the abutting portion extends toward the gap of the clamping portion. Each end of the clamping portion includes a protrusion on an inner face thereof or a rugged inner face. Accordingly, the abutting portion can be abutted against by the fingertip of the user to avoid movement of the body relative to the finger and the body is more reliably positioned on the finger.

In a most preferred form, the distal end of the abutting portion extends toward the gap of the clamping portion to a position aligned with and spaced from the gap. Furthermore, the distal end of the abutting portion has an end portion extending away from the gap of the clamping portion. Accordingly, the abutting portion provides intimate contact with the finger of the user so that the body can be more securely held on the finger of the user, and fingers of larger sizes can still be received in a compartment defined by the clamping portion and the abutting portion.

In a most preferred form, the touch member includes a connecting portion on the other end thereof. The connecting portion is interconnected to the outer periphery of the clamping portion and aligned with the abutting portion. A transition portion extends from the connecting portion in a radial direction perpendicular to the longitudinal axis and coupled to the outer periphery of the clamping portion. A gap is formed between the outer periphery of the clamping portion and a remaining portion of the touch member other than the transition portion. Accordingly, the fingertip touch pen can be clipped on an edge of a pocket, allowing easy carriage of the fingertip touch pen.

In a most preferred form, the abutting portion extends from the first side of the clamping portion and forms a closure enclosing the first side of the clamping portion. The second side of the clamping portion includes an opening. Furthermore, a part of the clamping portion close to an edge thereof expands outward in a radial direction perpendicular to the longitudinal axis to form an outwardly-expanding section, wherein the edge of the clamping portion defines the opening. There is a spacing between an inner face of the outwardly-expanding section and the longitudinal axis which is larger than that between a remaining portion of an inner periphery of the opening and the longitudinal axis. Further, the clamping portion includes a slit extending in a direction parallel to the longitudinal axis from an end face of the second side of the clamping portion having the opening. Accordingly, the body can completely enclose the fingertip of the finger of the user and insertion of fingers of larger sizes into the body is allowed.

In a most preferred form, the abutting portion has an outermost point that is most distant to the first side of the clamping portion. The touch portion of the touch member extends away from the second side of the clamping portion in a direction parallel to the longitudinal axis. There is a spacing between the touch portion and the second side of the clamping portion which is larger than that between the outermost point of the abutting portion and the second side of the clamping portion. Accordingly, the user can operate an electronic device with the touch portion of the touch member contacting a touch panel of the electronic device.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 shows a perspective view of a fingertip touch pen of a first embodiment according to the preferred teachings of the present invention.

FIG. 2 is a cross sectional view illustrating mounting of the fingertip touch pen of FIG. 1 on a fingertip of a user.

FIG. 3 is a schematic perspective view illustrating operation of an electronic device with the fingertip touch pen.

FIG. 4 shows a perspective view of a fingertip touch pen of a second embodiment according to the preferred teachings of the present invention.

FIG. 5 shows a schematic perspective view of the fingertip touch pen received in a pocket.

FIG. 6 shows a perspective view of a fingertip touch pen of a third embodiment according to the preferred teachings of the present invention.

FIG. 7 is a cross sectional view illustrating mounting of the fingertip touch pen of FIG. 6 on a fingertip of a user.

FIG. 8 shows a perspective view of a fingertip touch pen of a fourth embodiment according to the preferred teachings of the present invention.

FIG. 9 is a cross sectional view illustrating mounting of the fingertip touch pen of FIG. 8 on a fingertip of a user.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “inner”, “outer”, “end”, “portion”, “section”, “longitudinal”, “radial”, “annular”, “outward”, “spacing”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

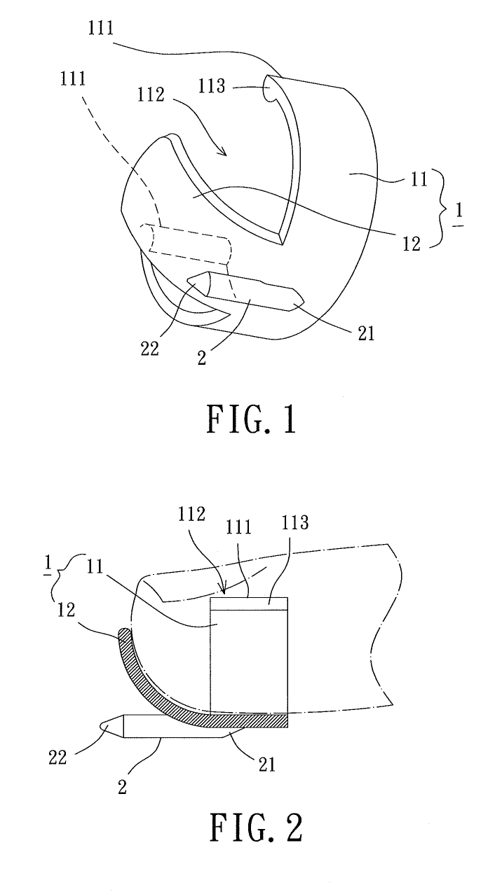

A fingertip touch pen of a first embodiment according to the preferred teachings of the present invention is shown in FIG. 1 of the drawings. According to the preferred form shown, the fingertip touch pen includes a body 1 and a touch member 2 coupled to an outer periphery of the body 1. The body 1 is made of a resilient material or metal so that the elasticity of the body 1 allows it to be mounted around fingers of differing sizes of various users. The body 1 includes an annular clamping portion 11 adapted to be mounted around a finger of a user, with the elasticity of the resilient material or metal providing a restoring force to clamp the finger so that the body 1 can be securely positioned on the finger. The elasticity of the body 1 also avoids breakage or permanent bending when an external force is imparted to an inner periphery of the body 1. The clamping portion 11 includes a first side and a second side spaced from the first side along a longitudinal axis of the clamping portion 11. The body 1 further includes an abutting portion 12 formed on the clamping portion 11 and protruding beyond the first side of the clamping portion 11. Furthermore, the abutting portion 12 extends toward the longitudinal axis. Further, the abutting portion 12 is interconnected to the clamping portion 11 at a portion that extends away from the second side of the clamping portion 11.

According to the preferred form shown, the clamping portion 11 of the body 1 is substantially C-shaped and includes two ends 111 having a gap 112 therebetween. The ends 111 are adapted for securely clamping two sides of the finger of the user. According to the most preferred form shown, each end 111 includes a protrusion 113 on an inner face thereof for clamping purposes. As mentioned above, the abutting portion 12 is formed on the first side of the clamping portion 11 and has a distal end not connected to the clamping portion 11. The distal end of the abutting portion 12 extends toward the gap 112 of the clamping portion 11, forming an arcuate abutting portion 12.

The touch member 2 includes a connecting portion 21 and a touch portion 22. The connecting portion 21 is on an end of the touch member 2 and interconnected to the outer periphery of the clamping portion 11 and aligned with the abutting portion 12. The touch member 2 extends along the longitudinal axis of the body 1. The touch portion 22 is formed on the other end of the touch member 2 and extends in a direction parallel to the longitudinal axis away from the second side of the clamping portion 11. There is a spacing between the touch portion 22 and the second side of the clamping portion 11, which is larger than that between an outermost point of the abutting portion 12 and the second side of the clamping portion 11, wherein the outermost point of the abutting portion 12 is most distant to the first side of the clamping portion 11.

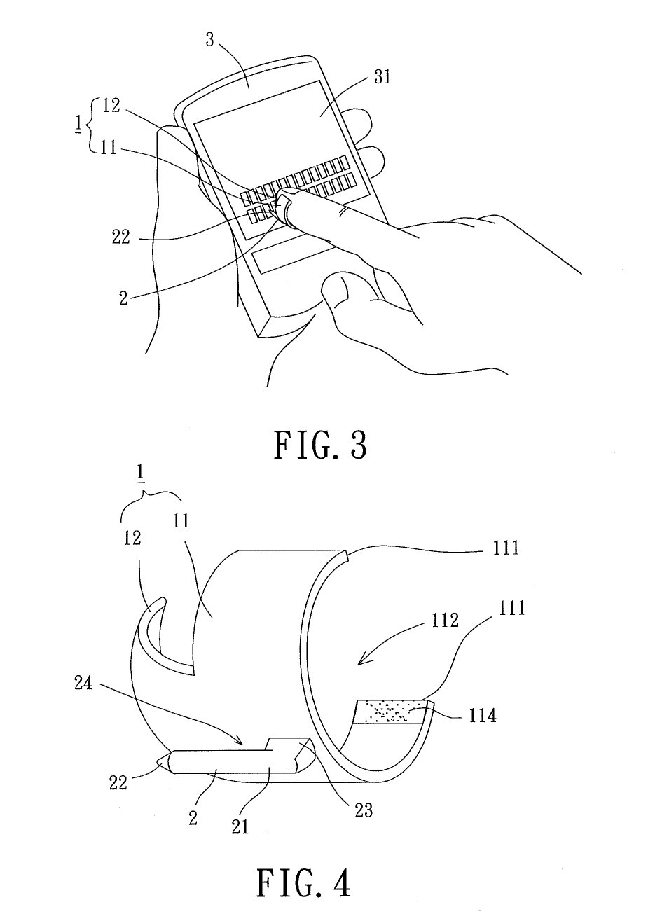

In use, with reference to FIGS. 2 and 3, the body 1 is directly mounted around the finger of the user at a portion adjacent to a fingertip of the finger. The protrusions 113 clamp the two sides of the finger so that the body 1 is more reliably positioned on the finger. The fingertip of the user abuts against the abutting portion 12. The user can use the touch portion 22 of the touch member 2 to contact a touch panel 31 of an electronic device 3 for operating the electronic device 3 (FIG. 3). When the fingertip touch pen comes in contact with the touch panel 31, the abutting portion 12 avoids movement of the body 1 relative to the finger, providing enhanced positioning effect.

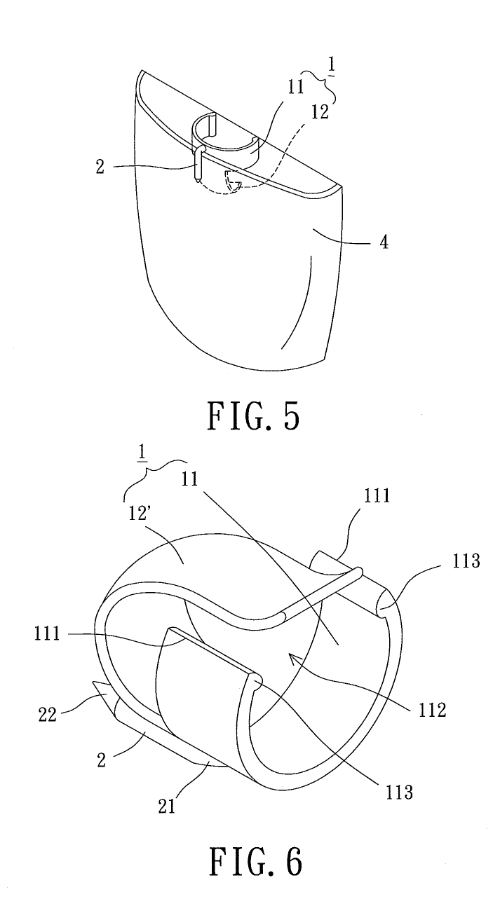

FIGS. 4 and 5 show a fingertip touch pen of a second embodiment according to the preferred teachings of the present invention. In this embodiment, each end 111 of the clamping portion 11 includes a rugged inner face 114 to provide friction between the clamping portion 11 and the finger of the user, providing enhanced positioning of the clamping portion 11 on the finger of the user. Furthermore, the touch member 2 further includes a transition portion 23 extending from the connecting portion 21 in a radial direction perpendicular to the longitudinal axis and coupled to the outer periphery of the clamping portion 11. Thus, a gap 24 is formed between the outer periphery of the clamping portion 11 and a remaining portion of the touch member 2 other than the transition portion 23. This gap 24 allows the fingertip touch pen to be clipped on an edge of a pocket 4 (FIG. 5), allowing easy carriage of the fingertip touch pen according to the preferred teachings of the present invention.

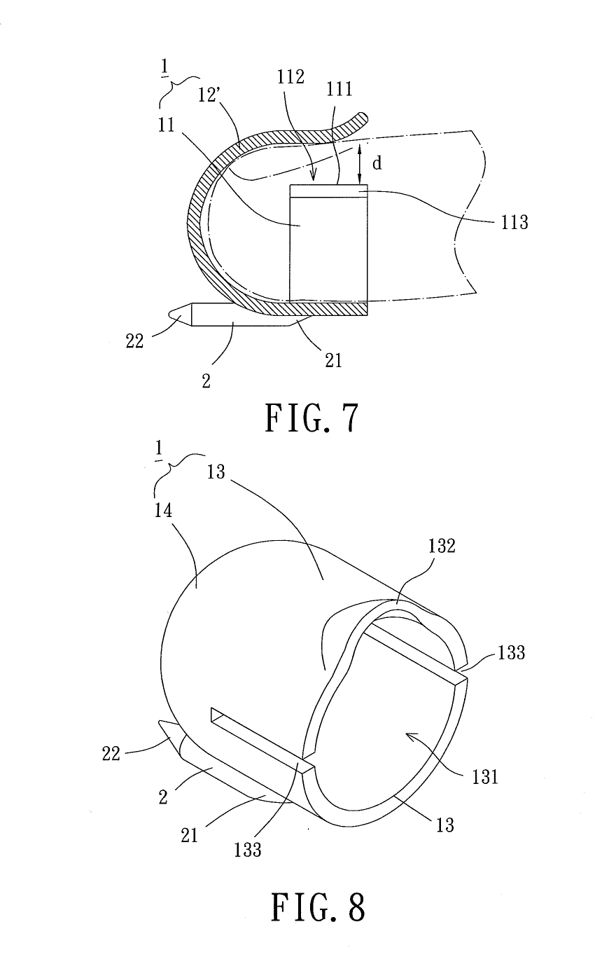

FIGS. 6 and 7 show a fingertip touch pen of a third embodiment according to the preferred teachings of the present invention. In this embodiment, the distal end of the abutting portion 12′ extends toward the gap 112 of the clamping portion 11 to a position aligned with and spaced from the gap 112 by a spacing “d”. By such an arrangement, in addition to avoiding movement of the clamping portion 11 relative to the finger of the user, the abutting portion 12′ provides intimate contact with the finger of the user so that the body 1 can be more securely held on the finger of the user, further enhancing positioning of the fingertip touch pen according to the preferred teachings of the present invention on the user of the finger. Furthermore, the distal end of the abutting portion 12′ has an end portion extending away from the gap 112 of the clamping portion 11 so that fingers of larger sizes can still be received in a compartment defined by the clamping portion 11 and the abutting portion 12′.

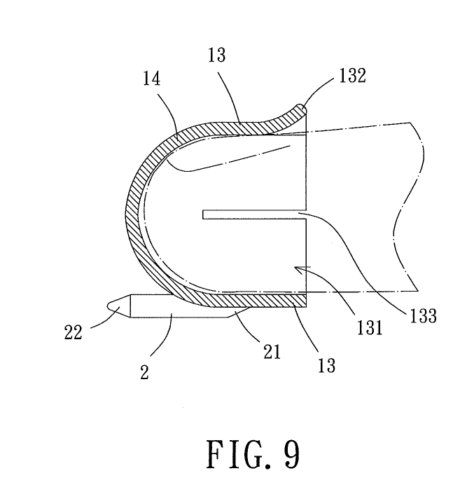

FIGS. 8 and 9 show a fingertip touch pen of a fourth embodiment according to the preferred teachings of the present invention. In this embodiment, the body 1 includes a clamping portion 13 and an abutting portion 14. The gap 112 and the protrusions 113 in the first embodiment are omitted. The abutting portion 14 is coupled to the clamping portion 13 at a location adjacent to the touch portion 22 of the touch member 2. Furthermore, the abutting portion 14 extends from the first side of the clamping portion 13 and forms a closure enclosing the first side of the clamping portion 13. The second side of the clamping portion 13 includes an opening 131. Further, a part of the clamping portion 13 close to an edge thereof expands outward in a radial direction perpendicular to the longitudinal axis to form an outwardly-expanding section 132, wherein the edge of the clamping portion 13 defines the opening 131. There is a spacing between an inner face of the outwardly-expanding section 132 and the longitudinal axis, which is larger than that between a remaining portion of an inner periphery of the opening 131 and the longitudinal axis. The touch portion 22 of the touch member 2 extends beyond a top of the abutting portion 14 in the form of a closure. Further, the clamping portion 13 includes two slits 133 extending in a direction parallel to the longitudinal axis from an end face of the second side of the clamping portion 13 having the opening 131. It can be appreciated that the clamping portion 13 can include only one or more than two slits 133. Thus, the body 1 can completely enclose the fingertip of the finger of the user without the risk of movement of the body 1. The outwardly-expanding section 132 and the slits 133 allow insertion of fingers of larger sizes into the body 1, improving convenience of use.

The clamping portion 11, 13 of the fingertip touch pen according to the preferred teachings of the present invention can be mounted around fingers of differing sizes of various users, with the abutting portion 12, 12′, 14 abutting against the fingertip to avoid movement of the body 1 relative to the finger. Enhanced positioning of the fingertip touch pen on the finger of the user is, thus, provided, providing convenient use of the fingertip touch pen.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A fingertip touch pen comprising:
a body including an annular clamping portion adapted to be mounted around a finger of a user at a portion adjacent to a fingertip of the finger, with the clamping portion including a first side and a second side spaced from the first side along a longitudinal axis of the clamping portion, with the clamping portion further including an outer periphery, with the body further including an abutting portion formed on the clamping portion and protruding beyond the first side of the clamping portion, with the abutting portion extending toward the longitudinal axis, with the abutting portion being interconnected to the clamping portion at a portion that extends away from the second side of the clamping portion, with the abutting portion being adapted to be abutted against by the fingertip of the user; and
a touch member coupled to the outer periphery of the clamping portion, with the touch member including a touch portion on an end thereof.

2. The fingertip touch pen as claimed in claim 1, with the clamping portion being substantially C-shaped and including two ends having a gap therebetween, and with the two ends being adapted for clamping the finger of the user, with the abutting portion being arcuate and having a distal end not connected to the clamping portion, and with the distal end of the abutting portion extending toward the gap of the clamping portion.

3. The fingertip touch pen as claimed in claim 2, with the distal end of the abutting portion extending toward the gap of the clamping portion to a position aligned with and spaced from the gap.

4. The fingertip touch pen as claimed in claim 3, with the distal end of the abutting portion having an end portion extending away from the gap of the clamping portion.

5. The fingertip touch pen as claimed in claim 1, with the touch member including a connecting portion on another end thereof, and with the connecting portion being interconnected to the outer periphery of the clamping portion and aligned with the abutting portion.

6. The fingertip touch pen as claimed in claim 5, with the touch member further including a transition portion extending from the connecting portion in a radial direction perpendicular to the longitudinal axis and coupled to the outer periphery of the clamping portion, and with a gap being formed between the outer periphery of the clamping portion and a remaining portion of the touch member other than the transition portion.

7. The fingertip touch pen as claimed in claim 2, with each of the two ends of the clamping portion including a protrusion on an inner face thereof.

8. The fingertip touch pen as claimed in claim 2, with each of the two ends of the clamping portion including a rugged inner face.

9. The fingertip touch pen as claimed in claim 1, with the abutting portion extending from the first side of the clamping portion and forming a closure enclosing the first side of the clamping portion, and with the second side of the clamping portion including an opening.

10. The fingertip touch pen as claimed in claim 9, with a part of the clamping portion close to an edge thereof expands outward in a radial direction perpendicular to the longitudinal axis to form an outwardly-expanding section, wherein the edge of the clamping portion defines the opening, with there being a spacing between an inner face of the outwardly-expanding section and the longitudinal axis, which is larger than that between a remaining portion of an inner periphery of the opening and the longitudinal axis.

11. The fingertip touch pen as claimed in claim 9, with the clamping portion including a slit extending in a direction parallel to the longitudinal axis from an end face of the second side of the clamping portion having the opening.

12. The fingertip touch pen as claimed in claim 9, with the with the touch member including a connecting portion on another end thereof, and with the connecting portion being interconnected to the outer periphery of the clamping portion and aligned with the abutting portion.

13. The fingertip touch pen as claimed in claim 12, with the with the touch member further including a transition portion extending from the connecting portion in a radial direction perpendicular to the longitudinal axis and coupled to the outer periphery of the clamping portion, and with a gap being formed between the outer periphery of the clamping portion and a remaining portion of the touch member other than the transition portion.

14. The fingertip touch pen as claimed in claim 1, with the abutting portion having an outermost point that is most distant to the first side of the clamping portion, and with the touch portion of the touch member extending away from the second side of the clamping portion in a direction parallel to the longitudinal axis, with there being a spacing between the touch portion and the second side of the clamping portion, which is larger than that between the outermost point of the abutting portion and the second side of the clamping portion.
